(19) United States
(12) Patent Application Publication
(10) Pub. No.: US 2006/0174098 A1
(43) Pub. Date: Aug. 3, 2006

(54) READ/WRITE CARD FOR FLASH MEMORY

(76) Inventor: Chin-Liang Chen, Penghu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,038

(22) Filed: Aug. 26, 2005

(30) Foreign Application Priority Data
Feb. 2, 2005 (TW) 94103174

(51) Int. Cl. G06F 15/177

(52) U.S. Cl. 713/1

(57) ABSTRACT

A read/write card for a flash memory is provided to perform a startup process of a main board and a burning process of a burner. The read/write card of the flash memory comprises an interface card, a flash memory, a burner adaptor, and a processing unit. The flash memory card is disposed over the interface card and comprises a startup program to restart the main board if the main board cannot normally function. In addition, the burner can re-write a startup program in the flash memory through the processing unit.

### CROSS-REFERENCE TO RELATED APPLICATION

This application claims the priority benefit of Taiwan application serial no. 94103174, filed on Feb. 2, 2005. All disclosure of the Taiwan application is incorporated herein by reference.

### BACKGROUND OF THE INVENTION

1. Field of the Invention

The present invention relates to a read/write card, and more particularly to a read/write card for a flash memory.

2. Description of the Related Art

A basic input/output system (BIOS) is a program permanently stored in a read-only memory (ROM) and will not be erased even the power is shut off. The BIOS defines a set of job commands and closely cooperates with hardware to support data transmission of each separate unit (e.g. memory, soft/hard disks and display devices) in a system. The latest main board usually comprises a flash erasable-programmable read only memory (Flash EPROM) convenient to burn the BIOS program for further program updating and debugging.

Though the Flash EPROM can easily update or debug the BIOS program through software, an expensive socket must be installed on the main board. The poor contact between the socket and the main board, however, affects the writing quality. If a socket has not installed, the Flash EPROM needs to be de-welded before disposing the burner when the updated and debugged BIOS program codes are not usable. Only through the re-written complete program codes by the burner can the BIOS program correctly be executed. However, the whole process often damages or shortens the life time of the integrated circuits in the memory.

In the prior art technology, if the BIOS program codes are going to be burned in the Flash EPROM, additional socket with the same specification is required which increases the cost. Moreover, during the process of removing the pins of the Flash EPROM, poor contact of the Flash EPROM in the subsequent assembly process occurs and the BIOS program cannot be normally executed.

### SUMMARY OF THE INVENTION

Accordingly, the present invention is directed to a read/write card for a flash memory. Without purchasing additional socket and adding expensive sockets on the main board, so that the cost is reduced.

The present invention is also directed to a read/write card for a flash memory. If the flash memory on the main board cannot normally operate the BIOS program, the read/write card executes the startup program. After the startup, the BIOS program is then re-written in the flash memory on the main board.

The present invention provides a read/write card for a flash memory to execute a startup process of a main board and a burning process of a burner. The read/write card of the flash memory comprises an interface card, a flash memory, a burner adaptor, and a processing unit. The interface card comprises a transmission interface and is adapted to be coupled to the main board. The flash memory is disposed over the interface card and stores a startup program. If the main board cannot be normally started up, the startup program of the flash memory is accessed for startup. The burner adaptor is disposed over the interface card and adapted to be coupled to the burner. The processing unit is disposed over the interface card. The burner writes the startup program to the flash memory through the processing unit.

According to a preferred embodiment of the present invention, the processing unit comprises at least one flip-flop, at least one counter, and a buffer. Wherein, the flip-flop is coupled between the burner adaptor and the flash memory. The counter provides a clock signal to the flip-flop, and the buffer stores data to be written in the flash memory.

According to a preferred embodiment of the present invention, the flip-flop can be, for example, a D-type flip-flop. The counter can be, for example, a binary counter. The buffer comprises, for example, a high-voltage state, a low-voltage state, and a high-impedance-voltage state.

In this present invention, the interface card is directly plugged to the main board to access the startup program of the flash memory for startup. Without purchasing additional socket and adding expensive sockets on the main board, the cost is reduced. In addition, after the startup has completed, the updated or debugged BIOS program is re-written in the flash memory of the main board. Accordingly, the pin damage of the Flash EPROM resulting from the prior art removal process can be avoided.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a schematic drawing showing a read/write card for a flash memory and a main board according to a preferred embodiment of the present invention.

FIG. 2 is a schematic drawing showing a read/write card for a flash memory and a burner according to a preferred embodiment of the present invention.

### DESCRIPTION OF SOME EMBODIMENTS

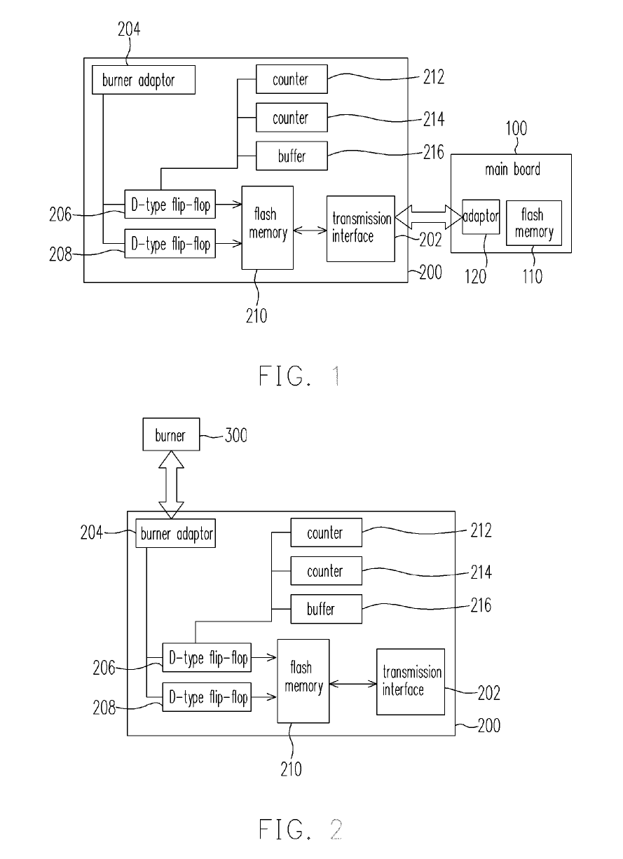

FIG. 1 is a schematic drawing showing a read/write card for a flash memory and a main board according to a preferred embodiment of the present invention. In this embodiment, when the main board 100 is going to execute the startup process (i.e., BIOS program) stored in a flash memory 110, such as a Flash EPROM. The program is accessed to execute a set of job commands so that the software and the hardware closely cooperate to support data transmission between each separate unit in the system, such as dynamic random access memory (DRAM), soft/hard disk drivers, displayers, or monitors (not shown) .etc. To avoid the abnormal function of the BIOS program, in the present invention the interface card 200 of the flash memory 210 can be plugged into a adaptor 120, such as a card-insertion connector or a socket, of the main board 100. If the main board 110 cannot perform the startup process through its own flash memory 110, the flash memory 210 over the interface card 200 is used for startup. Accordingly, the damage to the internal integrated circuits attributed to the removal or de-welding process of the flash memory 110 can be prevented.

Referring to FIG. 1, the interface card 200 is, for example, a circuit board with a transmission interface 202. The flash memory 210 can be, for example, a flash erasable-programmable read only memory (Flash EPROM) for storing a startup program. The startup program can be written by directly complying the program codes through a software after the startup of the main board 100. The purpose is that when the main board 100 cannot normally start up, the startup program stored in the flash memory 210 is set to be first accessed for the startup of the main board 100 by a switch or a jump method. Thus, the main board 100 can normally access the system. After the startup, the BIOS program stored in the flash memory 110 over the main board 100 can be re-written so that the system can normally function.

FIG. 2 is a schematic drawing showing a read/write card for a flash memory and a burner according to a preferred embodiment of the present invention. In this embodiment, while the burner 300 performs the burning process, additional socket with the same specification is not required. The burner adaptor 204 over the interface card 200 is directly coupled to the burner 300 to write the updated BIOS program in the flash memory 210 over the interface card 200 for debugging. During the debug process, the damage to the flash memory over the main board 100 in FIG. 1 can be avoided and its life time is thus extended. Finally, once the updated BIOS program can normally function, the updated or debugged BIOS program is re-written in the flash memory 110 of the main board 100. The whole process is, therefore, done.

Referring to FIG. 2, in this embodiment the processing unit comprises, for example, two D-type flip-flops 206 and 208, two counters 212 and 214, and a buffer 216 to write the BIOS program codes and its address data in the flash memory 210 of the interface card 200. Wherein, the D-type flip-flops 206 and 208 are coupled between the burner adaptor 204 and the flash memory 210. The D-type flip-flops 206 and 208 synchronously process binary signals according to a clock signal provided by the counters 212 and 214. The buffer 216 comprises, for example, a high-voltage state, a low-voltage state, and a high-impedance-voltage state to register the data to be stored in the flash memory 210.

Accordingly, the present invention discloses a read/write card for a flash memory to execute a startup process of a main board, and a burning process of a burner. The read/write card of the flash memory comprises an interface card, a flash memory, a burner adaptor, and a processing unit. The flash memory is disposed over the interface card and stores a startup program. If the main board cannot be normally started up, the startup program of the flash memory is accessed for startup. In addition, the burner can write additional startup program in the flash memory through the processing unit. Accordingly, without purchasing additional socket and adding expensive sockets on the main board, the read/write card of the present invention will reduce the manufacturing cost. If the flash memory over the main board cannot normally execute the BIOS program, the flash memory over the interface card can normally perform the startup process. After the startup has completed, the updated or debugged BIOS program is re-written in the flash memory of the main board. The flash memory over the main board will not be damaged.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A read/write card for a flash memory to execute a startup process of a main board and a burning process of a burner, the main board comprising a adaptor, the read/write card of the flash memory comprising:
an interface card, comprising a transmission interface, the interface card being adapted to be coupled to the main board;
a flash memory, disposed over the interface card and storing a startup program, if the main board cannot be normally started up, the startup program of the flash memory being accessed for startup;
a burner adaptor, disposed over the interface card and adapted to be coupled to the burner; and
a processing unit, disposed over the interface card, the burner writing the startup program to the flash memory through the processing unit.

2. The read/write card for a flash memory of claim 1, wherein the flash memory is a flash erasable programmable read only memory (Flash EPROM).

3. The read/write card for a flash memory of claim 1, wherein the processing unit comprises at least one flip-flop, at least one counter, and a buffer, wherein the flip-flop is coupled between the burner adaptor and the flash memory, the counter provides a clock signal to the flip-flop, and the buffer stores data to be written in the flash memory.

4. The read/write card for a flash memory of claim 1, wherein the flip-flop comprises a D-type flip-flop.

5. The read/write card for a flash memory of claim 1, wherein the counter comprises a binary counter.

6. The read/write card for a flash memory of claim 1, wherein the buffer comprises a high-voltage state, a low-voltage state, and a high-impedance-voltage state.
